(19) United States
(12) Patent Application Publication
(10) Pub. No.: US 2020/0233552 A1
(43) Pub. Date: Jul. 23, 2020

(54) VOIDING ACCIDENTALLY COPIED DATA ITEMS

(71) Applicant: INTERNATIONAL BUSINESS MACHINES CORPORATION, ARMONK, NY (US)

(72) Inventor: Adaoha Onyekwelu, WAPPINGERS FALLS, NY (US)

(21) Appl. No.: 16/255,250

(22) Filed: Jan. 23, 2019

(51) Int. Cl. G06F 3/0486; G06F 17/24

(52) U.S. Cl. CPC G06F 3/0486; G06F 17/24

(57) ABSTRACT

A method for providing nullification of unintentionally copied data includes detecting a copy operation associated with a data item. A determination is made if the data item associated with the copy operation includes valid data. A previously stored data item is recalled, in response to determining that the data item associated with the copy operation does not include valid data. The data item associated with the copy operation is stored, in response to determining that the data item associated with the copy operation includes valid data. A paste operation is initiated to selectively insert the data item associated with the copy operation or the previously stored data item based on the validity of data into an application.

### BACKGROUND

The present invention relates to data processing systems and, more specifically, voiding accidentally copied data items.

Computing devices have long supported various editing actions such as copy, cut and paste. A copy action is generally performed after a user has selected some displayed content, and results in the selected content being copied to a temporary storage commonly referred to as a clipboard. A paste action is generally performed when a user desires to insert previously-copied content elsewhere and results in the previously-copied content in a clipboard being inserted at a user-specified location. A cut action may be considered to be a sub-type of a copy action, as like a copy action, a cut action causes selected content to be copied to a clipboard. However, with a cut action, the selected content is then deleted from its original location.

During manual editing, users can modify (add, delete, copy and paste etc.) any text within a document or application. Typically, when copying and pasting between different panels/windows of one or more applications the user might mistakenly copy empty data. For example, computer-proficient users may utilize certain keyboard shortcuts to perform editing operations and may accidentally press CTRL-C (to copy text) instead of CTRL-V (to paste text). Such actions could cause frustration and could be inconveniencing, wasting time and requiring additional steps of reopening previously closed window or application to re-copy the data.

### SUMMARY

Embodiments of the present invention are directed to a computer-implemented method for providing nullification of an unintentionally copied data item. A non-limiting example of the computer-implemented method includes detecting a copy operation associated with a data item. A determination is made if the data item associated with the copy operation includes valid data. A previously stored data item is recalled, in response to determining that the data item associated with the copy operation does not include valid data. The data item associated with the copy operation is stored, in response to determining that the data item associated with the copy operation includes valid data. A paste operation is initiated to selectively insert the data item associated with the copy operation or the previously stored data item based on the validity of data into an application.

Embodiments of the present invention are directed to a system for providing nullification of an unintentionally copied data item. A non-limiting example of the system includes a memory having computer-readable instructions and one or more processors for executing the computer-readable instructions. The computer-readable instructions include detecting a copy operation associated with a data item. A determination is made if the data item associated with the copy operation includes valid data. A previously stored data item is recalled, in response to determining that the data item associated with the copy operation does not include valid data. The data item associated with the copy operation is stored, in response to determining that the data item associated with the copy operation includes valid data. A paste operation is initiated to selectively insert the data item associated with the copy operation or the previously stored data item based on the validity of data into an application.

Embodiments of the invention are directed to a computer-program product for providing nullification of an unintentionally copied data item, the computer-program product including a computer-readable storage medium having program instructions embodied therewith. The program instructions are executable by a processor to cause the processor to perform a method. A non-limiting example of the method includes detecting a copy operation associated with a data item. A determination is made if the data item associated with the copy operation includes valid data. A previously stored data item is recalled, in response to determining that the data item associated with the copy operation does not include valid data. The data item associated with the copy operation is stored, in response to determining that the data item associated with the copy operation includes valid data. A paste operation is initiated to selectively insert the data item associated with the copy operation or the previously stored data item based on the validity of data into an application.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a conceptual diagram illustrating an example of providing nullification of an unintentionally copied data item with a clipboard manager application, in accordance with embodiments of the present invention;

FIG. 2 is a display diagram illustrating components of a scheme to provide nullification of an unintentionally copied data item with a clipboard manager application, in accordance with embodiments of the present invention;

FIG. 3 shows a flow diagram of a method for providing nullification of the unintentionally copied data item, in accordance with embodiments of the present invention; and

FIG. 4 is a block diagram of an example computer system for implementing some or all aspects of the method for providing nullification of the unintentionally copied data item, in accordance with embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two- or three-digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, a clipboard manager application may provide nullification of an unintentionally copied data item. In an example scenario, the clipboard manager application may detect a copy operation. The copy operation may capture a selected item and store the item in a cache (such as a system clipboard) in preparation for a paste operation.

Next, a paste input may be intercepted. The paste input may include an input detected as associated with a paste operation. The clipboard manager application may override a workflow of a default system paste operation by selectively pasting a previously stored data item if the currently copied data item is invalid.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Throughout this specification, the term “platform” may be a combination of software and hardware components to provide an invalid copy data nullification feature with a clipboard manager application. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smartphone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

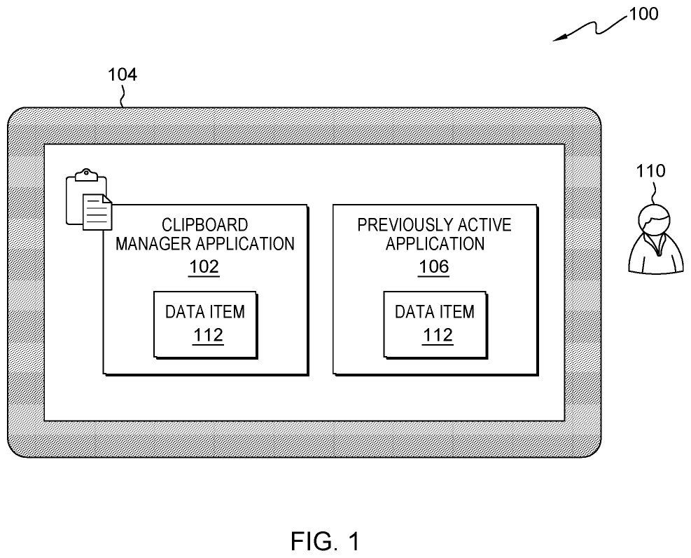

FIG. 1 is a conceptual diagram illustrating examples of providing nullification of an unintentionally copied data item with a clipboard manager application, according to embodiments.

In diagram 100, a computing device 104 may execute a clipboard manager application 102. The computing device 104 may include a physical computer and/or a mobile computing device such as a smartphone and/or similar devices. The computing device 104 may also include a special purpose and/or configured device that is optimized to execute data operations associated with the clipboard manager application 102. For example, the computing device 104 may include physical components that are custom built to accelerate copy and/or paste operations through multiple computation cores tailored to manage a number of items selected for the copy and/or paste operations.

The computing device 104 may execute the clipboard manager application 102. The clipboard manager application 102 may initiate operations to provide nullification of an unintentionally copied data item upon detecting a copy operation (such as a copy operation initiated by a user 110). The copy operation may capture a data item 112 (that is selected) and store the data item 112 in a cache (such as a system clipboard) in preparation for a paste operation. The data item may include data (such as text, an image) and/or a file (such as a document), among others. The clipboard manager application 102 may replace (or override) a workflow of an operating system (that provides copy and paste operations) with a selective insertion features for managing data item(s) selected for copy and paste operations.

In response to detecting the copy operation, the data item 112 associated with the copy operation may be stored. The data item may be stored in a local cache accessible by the clipboard manager application 102. Alternatively, the clipboard manager application 102 may store the data item in a system clipboard provided by an operating system (OS). The data item 112 may be stored along with previously stored data item(s). The OS may execute and/or manage the clipboard manager application 102 and other application(s) associated with the copy and/or paste operations.

Next, a paste input may be intercepted. The paste input may be detected as provided by the user 110. Furthermore, the pasted input may include an input detected as associated with a paste operation. The clipboard manager application 102 may replace a workflow of a default system paste operation by determining whether the data item 112 to be copied is valid and by voiding accidentally copied data item. Upon detecting the data item 112 as selected, the data item 112 may be inserted into a previously active application 106, for example. The previously active application 106 may be identified as an application that previously had an OS focus (for example, the user 110 has interacted with the previously active application 106). The previously active application 106 may also provide the data item 112 for the copy operation. Alternatively, the data item 112 may also be inserted to an application selected by the user 110 (referred to hereinafter as currently active application) to complete the paste operation.

In the depicted example, the computing device 104 may communicate with other client device(s) or server(s) through a network. The network may provide wired or wireless communications between network nodes such as the computing device 104, other client device(s) and/or server(s), among others. Previous example(s) to provide nullification of an unintentionally copied data item with the clipboard manager application 102 are not provided in a limiting sense. Alternatively, the copy and/or paste operations may be intercepted and processed by an application programming interface (API) for further operations, among others. Furthermore, a service hosted by a physical server may provide a client interface such as the clipboard manager application 102 that dynamically manages copy and/or paste operations at the computing device 104 (for example, a component of a browser application managing copy and/or paste operations).

The user 110 may interact with the clipboard manager application 102 with a keyboard based input, a mouse-based input, a voice-based input, a pen-based input, and a gesture-based input, among others. The gesture-based input may include one or more touch-based actions such as a touch action, a swipe action, and a combination of each, among others.

While the example system in FIG. 1 has been described with specific components including the computing device 104 and the clipboard manager application 102, embodiments are not limited to these components or system configurations and can be implemented with other system configuration employing fewer or additional components.

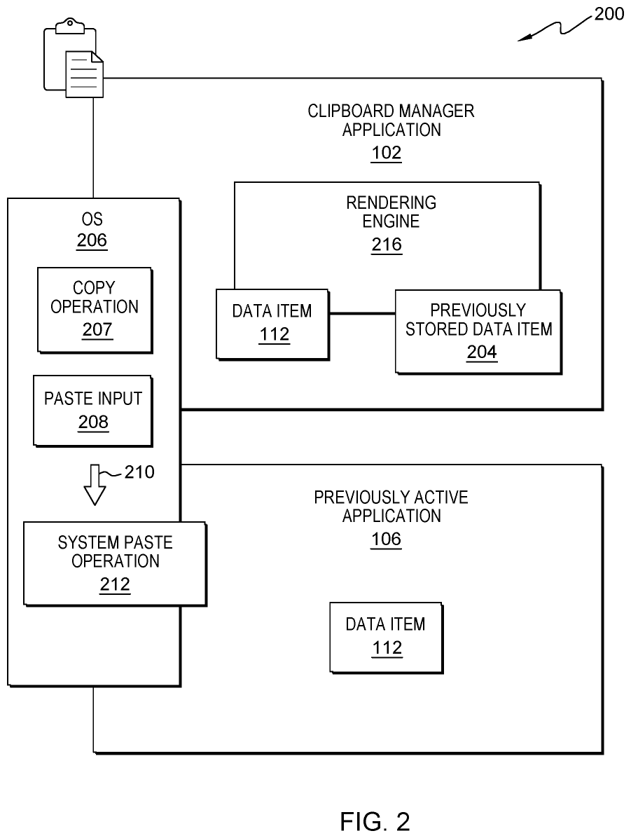

FIG. 2 is a display diagram illustrating components of a scheme to provide nullification of an unintentionally copied data item with a clipboard manager application, in accordance with embodiments of the present invention.

In diagram 200, a rendering engine 216 of a clipboard manager application 102 may store a data item 112 associated with a copy operation 207. The copy operation 207 may be initiated by a user. The target of the copy operation 207 may include a previously active application 106. As such, the clipboard manager application 102 may monitor OS focus shifts from the previously active application 106 to a currently active application.

The rendering engine 216 of the clipboard manager application 102 may identify the previously active application 106 by monitoring an application switch event emitted by an operating system 206. The OS 206 may trigger the application switch event whenever the OS 206 detects an OS focus shift from the previously active application 106 to a currently active application. For example, the OS 206 may trigger the application switch event in response to a user interaction to switch the OS focus from a UI of the previously active application 106 to a UI of a currently active application (not shown in FIG. 2).

The OS 206 may execute and manage the clipboard manager application 102 and the previously active application 106. As such, the clipboard manager application 102 may reside within an environment provided by the OS 206 and have access to operations executed by the OS 206. For example, the clipboard manager application 102 may record an application identifier upon detecting the application switch event. The application switch event may be exposed to the clipboard manager application 102 by the OS 206 or the clipboard manager application 102 may register with the OS 206 to receive the application switch event. The application switch event may include an application identifier that corresponds to the previously active application. The rendering engine 216 of the clipboard manager application 102 may identify the previously active application 106 from the application identifier. For example, the application identifier may include a process number associated with the previously active application 106. The process number may be used to identify the previously active application 106 and interact with the previously active application 106.

The rendering engine 216 of the clipboard manager application 102 may interrupt a copy and/or paste operation workflow of the OS 206 upon detecting a paste input 208. In response to detecting a selection of the data item 112, the rendering engine 216 may place the data item 112 into a system clipboard. The system clipboard may include a cache (to temporarily store the data item 112 during copy and/or paste operations) provided by the OS 206. The system clipboard may be used to initiate a system paste operation by the OS 206. The rendering engine 216 may provide one previously stored data item 204 to the clipboard manager application 102 in case the newly copied data item 112 is either empty or invalid. The rendering engine 216 may activate the previously active application 106 by shifting the OS focus to the previously active application 106. Next, the system paste operation may be initiated by prompting the OS 206 to insert either the data item 112 or the previously stored data item 204 into the previously active application 106.

In an example scenario, the rendering engine 216 of the clipboard manager application 102 may intercept a paste input 208 (provided by the user). The rendering engine 216 may intercept the paste input 208 by unregistering an OS trigger 210 between the paste input and a system paste operation 212. An unregister operation may instruct the OS 206 to stop initiating the OS trigger 210 to activate the system paste operation 212 upon detecting the paste input 208. As such, the clipboard manager application 102 may prevent the OS 206 from activating the system paste operation 212 automatically in response to the paste input 208.

The rendering engine 216 may instead selectively generate (and/or override) the system paste operation 212 based on the validity of data item 112. The system paste operation 212 may include instructions to insert the data item 112 into the previously active application 106. Next, the rendering engine 216 may initiate the system paste operation 212 to insert the data item 112 into the previously active application 106. Alternatively, the rendering engine 216 may also generate and/or overwrite the system paste operation 212 to insert the previously stored data item 204 into an application chosen by the user and/or by other entity controlling the clipboard manager application 102.

Moreover, the copy and/or paste operations may be restored to default flow of operations upon a deactivation of the clipboard manager application 102. Upon detecting a deactivation input, the clipboard manager application 102 may reregister the OS trigger 210 between the paste input 208 and the system paste operation 212 to restore the default flow of copy and/or paste operations. In response to the deactivation input, the clipboard manager application 102 may shut down and the OS 206 may manage paste and/or copy operations.

Advantageously, the clipboard manager application 102 can incorporate appropriate data item, for data copy operation performed between a currently active application and the previously active application 106, for example. This embodiment addresses the problem of voiding accidentally copied or empty data items. In other words, the clipboard manager application 102 is configured to automatically nullify/void an empty or erroneous selection of data.

Furthermore, as described above, the clipboard manager application 102 just reverts to the last data item copied/stored when it detects erroneous selection of data. This functionality enables the user to proceed with performing paste operation by using, for example, the shortcut key (CTRL-V) command. It should be noted that embodiments of the present invention are applicable to different types of data. Modern data processing systems, such as general purpose computer systems, allow users of such systems to create a variety of different types of data files. For example, a typical user of a data processing system may create text files with a word processing program such as Microsoft Word from Microsoft Corporation or may create an image file with an image processing program such as Adobe's Photo Shop. Numerous other types of files are capable of being created or modified, edited, and otherwise used by one or more users for a typical data processing system. Accordingly, the clipboard manager application 102 is capable of handling large number of the different types of data items that can be copied and pasted.

Modern data processing systems often include a file management system which allows a user to place files in various directories or subdirectories (e.g. folders) and allows a user to give the file a name. Further, these file management systems allow the clipboard manager application 102 to find a file (e.g., a file created by a previously active application 106) by searching for the file's name, or the date of creation, or the date of modification, or the type of file. An example of such a file management system is the Finder program which operates on Macintosh computers from Apple Computer, Inc. Another example of a file management system program is the Windows Explorer program which operates on the Windows operating system from Microsoft Corporation. Both the Finder program and the Windows Explorer program include a find command which allows the clipboard manager application 102 to search for files into which data needs to be copied by various criteria including a file name or a date of creation or a date of modification or the type of file.

At least in some embodiments, the clipboard manager application 102 understands when a break occurs by monitoring user's actions and by differentiating (at least) between different types of data copied from a currently active application, for example. As a non-limiting example illustrating functionality of the clipboard manager application 102 consider the following scenario. For example, a user may be interested in sending their favorite recipe to a friend using their mobile device. The user may copy a set of ingredients for a recipe from a web-page using the keyboard shortcut command (CTRL+C), close out or minimize a browser app and open a different app, such as a messaging app. Next, the user may erroneously use the wrong shortcut by pressing CTRL+C again instead of CTRL-V (to paste). In this scenario, the clipboard manager application 102 will realize that the user issued the second copy command without copying anything new. In other words, the second unintentional copy command has an empty data item. Advantageously, this empty data item would be voided by the clipboard manager application 102. Furthermore, the clipboard manager application 102 prioritizes the last copied data item (in this example the copied set of ingredients) for the performed Copy/Paste operation.

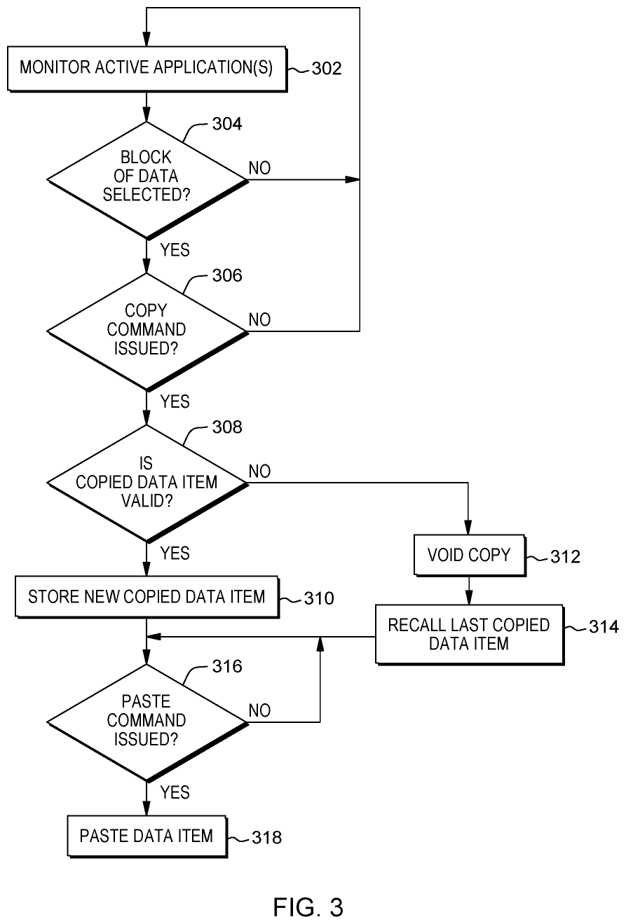

FIG. 3 is a flow diagram of a method for providing nullification of an unintentionally copied data item, in accordance with embodiments of the present invention. At block 302, the clipboard manager application 102 may start monitoring users' interactions with all active applications. According to one embodiment of the present invention, the clipboard manager application 102 may start monitoring real-time event data streams for particular events of interest. This step may be performed in conjunction with various well-known methods, such as, but not limited to data stream analysis operations. Block 302 includes determining by the clipboard manager application 102 a set of events to monitor for each application. The event may be a predetermined user input event. For example, monitored events may include the aforementioned keyboard shortcut combinations, such as Copy/Paste combinations, user's selection of a portion of text or image, application closing/minimizing events, and the like. In various embodiments, the clipboard manager application 102 may take into account multiple factors of information while monitoring various applications. Those skilled in the art will understand that various combinations of factors are possible and would fall within the scope of the various embodiments of the present invention.

At block 304, the clipboard manager application 102 determines if a data item has been selected by a user. For example, the clipboard manager application 102 may analyze the received streams of real-time data events to identify one or more presently selected data items. If the event analysis indicates there are no presently selected data items (decision block 304, “No” branch), the clipboard manager application 102 may continue monitoring presently active applications (block 302).

In response to determining that at least one data item has been selected by a user (decision block 304, “Yes” branch), at block 306, the clipboard manager application 102 may continue analyzing the received streams of real-time data events to determine whether the user initiated a copy command subsequently to selecting one or more data items. On desktop computers, commands are accessible through graphical menus. As noted above, frequent commands, such as copy and paste commands, are also accessible through keyboard shortcuts. Shortcuts are faster and less attention demanding than graphical menus. A user does not have to look for the menus whose locations vary from application to application. Certain shortcuts tend to be universal across applications. As noted above, Control-C typically executes a copy command. Similarly, Control-V typically executes a paste command. A user can reliably count on these basic operations for various software applications. However, embodiments of the present invention are not limited to desktop computers. Pen-based devices, including Tablet PCs, personal digital assistants (PDAs), and advanced smartphones, are increasingly important forms of computing and communication. One of the challenges to make these devices usable is the lack of physical input devices such as the mouse and the desktop keyboard. In such pen-based devices, commands, such as copy and paste commands, conventionally issued by the user through shortcuts and function keys in desktop computers, are activated by pen motions on a graphical keyboard. Embodiments of the present invention also relate to computing devices with touch sensing or trajectory sensing methods other than the digital pen, including electronic whiteboards and tabletop computers. Thus, at block 306, the clipboard manager application 102 may evaluate the received event streams to determine if a copy command is activated by any of the above methods. The clipboard manager application 102 may further determine an application associated with the copy operation. In response to determining that the copy command has not been activated by the user (decision block 306, “No” branch), the clipboard manager application 102 may return to the monitoring step (block 302).

Responsive to a determination that the user activated a copy command (decision block 306, “Yes” branch), at block 308, the clipboard manager application 102 may determine if the copied data item is valid. In accordance with one embodiment, the clipboard manager application 102 may determine, for example, if the corresponding selected data item is not empty. In addition, the clipboard manager application 102 may be configured to identify learned user patterns. In other words, the clipboard manager application 102 may be configured to analyze a plurality of previously stored items to identify one or more data patterns. As a non-limiting example, if the clipboard manager application 102 determines that last few copied and stored data items are associated with cooking recipes and if subsequently the user copied something unrelated to cooking recipes such as, for example, email address, the clipboard manager application 102 may make a determination that current data item breaks the pattern and may treat the copied email address as invalid data item. To recognize a pattern, the clipboard manager application 102 may employ a classifier. In one embodiment, such classifier may use a neural network to extrapolate from a small sampling of possible inputs. The neural network typically is trained with the sampling of data and uses various algorithms based on error estimation to classify unknown inputs.

Responsive to a determination that the copied data item is valid (decision block 308, “Yes” branch), at block 310, the clipboard manager application 102 may store the newly copied data item. For example, the copied data item can be stored in a local cache accessible by the clipboard manager application 102. Alternatively, the clipboard manager application 102 may store the data item in a system clipboard provided by the OS 206. The data item 112 may be stored along with previously stored data item(s).

Responsive to a determination that the copied data item is invalid (decision block 308, “No” branch), at block 312, the clipboard manager application 102 may void the newly copied data item. Next, at block 314, the clipboard manager application may recall the last stored data item from the storage, such as local cache, and may replace the invalid data item (e.g., empty data item) with the last stored data item.

According to an embodiment of the present invention, after storing the newly copied data item or replacing it with the previously stored data item, at block 316, the clipboard manager application 102 may determine whether the user initiated a paste command subsequently to copying one or more data items. Furthermore, the clipboard manager application 102 may determine whether the paste command is associated with the same application as the last copy command. In response to determining that the user initiated the paste command, at block 318, the clipboard manager application 102 may paste the one or more of the copied item(s) individually where and when the user intends (e.g., the previously active application 106).

Advantageously, the clipboard manager application 102 is configured to automatically nullify/void an empty or invalid selection of data without user's interaction with a user interface, such as Graphical User Interface (GUI).

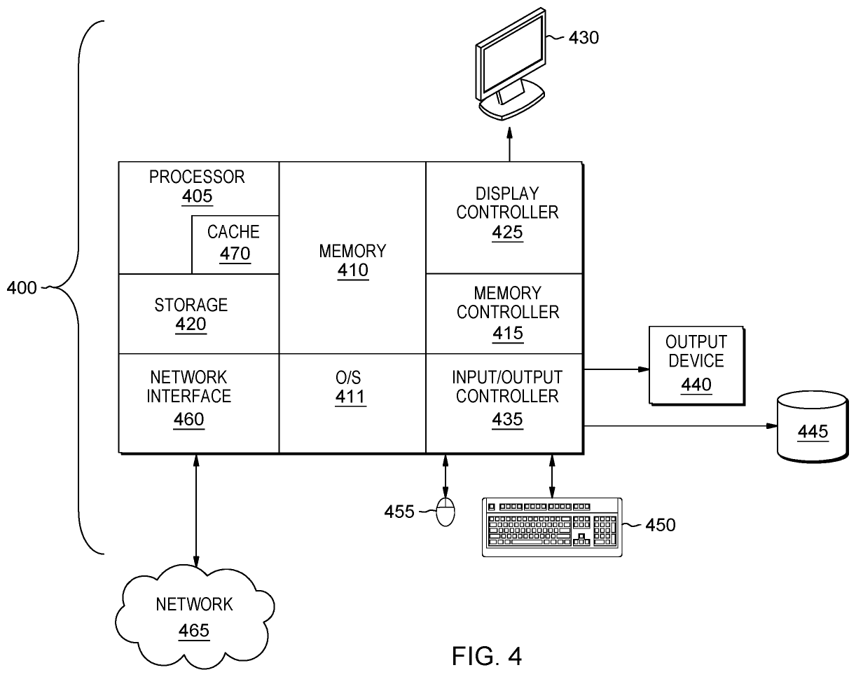

FIG. 4 is a block diagram of a computer system 400 for implementing some or all aspects of the clipboard manager application 102, according to some embodiments of this invention. The clipboard manager application 102 and methods described herein may be implemented in hardware, software (e.g., firmware), or a combination thereof. In some embodiments, the methods described may be implemented, at least in part, in hardware and may be part of the microprocessor of a special or general-purpose computer system 400, such as a personal computer, workstation, minicomputer, or mainframe computer. For instance, the clipboard manager application 102, the rendering engine 216 may each be implemented as a computer system 400 or may run on a computer system 400.

In some embodiments, as shown in FIG. 4, the computer system 400 includes a processor 405, memory 410 coupled to a memory controller 415, and one or more input devices 445 and/or output devices 440, such as peripherals, that are communicatively coupled via a local I/O controller 435. These devices 440 and 445 may include, for example, a printer, a scanner, a microphone, and the like. Input devices such as a conventional keyboard 450 and mouse 455 may be coupled to the I/O controller 435. The I/O controller 435 may be, for example, one or more buses or other wired or wireless connections, as are known in the art. The I/O controller 435 may have additional elements, which are omitted for simplicity, such as controllers, buffers (caches), drivers, repeaters, and receivers, to enable communications.

The I/O devices 440, 445 may further include devices that communicate both inputs and outputs, for instance disk and tape storage, a network interface card (MC) or modulator/demodulator (for accessing other files, devices, systems, or a network), a radio frequency (RF) or other transceiver, a telephonic interface, a bridge, a router, and the like.

The processor 405 is a hardware device for executing hardware instructions or software, particularly those stored in memory 410. The processor 405 may be a custom made or commercially available processor, a central processing unit (CPU), an auxiliary processor among several processors associated with the computer system 400, a semiconductor-based microprocessor (in the form of a microchip or chip set), a macroprocessor, or other device for executing instructions. The processor 405 includes a cache 470, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 470 may be organized as a hierarchy of more cache levels (L1, L2, etc.).

The memory 410 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 410 may incorporate electronic, magnetic, optical, or other types of storage media. Note that the memory 410 may have a distributed architecture, where various components are situated remote from one another but may be accessed by the processor 405.

The instructions in memory 410 may include one or more separate programs, each of which comprises an ordered listing of executable instructions for implementing logical functions. In the example of FIG. 4, the instructions in the memory 410 include a suitable operating system (OS) 411. The operating system 411 essentially may control the execution of other computer programs and provides scheduling, input-output control, file and data management, memory management, and communication control and related services.

Additional data, including, for example, instructions for the processor 405 or other retrievable information, may be stored in storage 420, which may be a storage device such as a hard disk drive or solid-state drive. The stored instructions in memory 410 or in storage 420 may include those enabling the processor to execute one or more aspects of the clipboard manager application 102 and methods of this disclosure.

The computer system 400 may further include a display controller 425 coupled to a display 430. In some embodiments, the computer system 400 may further include a network interface 460 for coupling to a network 465. The network 465 may be an IP-based network for communication between the computer system 400 and an external server, client and the like via a broadband connection. The network 465 transmits and receives data between the computer system 400 and external systems. In some embodiments, the network 465 may be a managed IP network administered by a service provider. The network 465 may be implemented in a wireless fashion, e.g., using wireless protocols and technologies, such as WiFi, WiMax, etc. The network 465 may also be a packet-switched network such as a local area network, wide area network, metropolitan area network, the Internet, or other similar type of network environment. The network 465 may be a fixed wireless network, a wireless local area network (LAN), a wireless wide area network (WAN) a personal area network (PAN), a virtual private network (VPN), intranet or other suitable network system and may include equipment for receiving and transmitting signals.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special-purpose hardware-based systems that perform the specified functions or acts or carry out combinations of special-purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A method to provide nullification of unintentionally copied data, the method comprising:
detecting a copy operation associated with a data item;
determining whether the data item associated with the copy operation comprises valid data, wherein a determination is made that the data item does not comprise valid data based at least in part on determining that the data item is empty;
recalling a previously stored data item, in response to determining that the data item associated with the copy operation does not comprise valid data;
storing the data item associated with the copy operation, in response to determining that the data item associated with the copy operation comprises valid data; and
initiating a paste operation to selectively insert the data item associated with the copy operation or the previously stored data item based on the validity of data into an application.

2. The method of claim 1, further comprising determining an application associated with the copy operation.

3. The method of claim 2, further comprising determining whether the application associated with the copy operation is the same as the application associated with the paste operation.

4. (canceled)

5. The method of claim 1, wherein determining whether the data item associated with the copy operation comprises valid data further comprises analyzing a plurality of previously stored items to identify one or more data patterns.

6. The method of claim 5, further comprising determining whether the data item associated with the copy operation matches the one or more data patterns.

7. The method of claim 1, wherein the copy operation is associated with two or more data items.

8. A system for providing nullification of unintentionally copied data, the system comprising:
a memory having computer-readable instructions; and
one or more processors for executing the computer-readable instructions, the computer-readable instructions comprising:
instructions for detecting a copy operation associated with a data item;
instructions for determining whether the data item associated with the copy operation comprises valid data, wherein a determination is made that the data item does not comprise valid data based at least in part on determining that the data item is empty;
instructions for recalling a previously stored data item, in response to determining that the data item associated with the copy operation does not comprise valid data;
instructions for storing the data item associated with the copy operation, in response to determining that the data item associated with the copy operation comprises valid data; and
instructions for initiating a paste operation to selectively insert the data item associated with the copy operation or the previously stored data item based on the validity of data into an application.

9. The system of claim 8, the computer-readable instructions further comprising instructions for determining an application associated with the copy operation.

10. The system of claim 9, the computer-readable instructions further comprising instructions for determining whether the application associated with the copy operation is the same as the application associated with the paste operation.

11. (canceled)

12. The system of claim 8, wherein the instructions for determining whether the data item associated with the copy operation comprises valid data further comprise instructions for analyzing a plurality of previously stored items to identify one or more data patterns.

13. The system of claim 12, the computer-readable instructions further comprising instructions for determining whether the data item associated with the copy operation matches the one or more data patterns.

14. The system of claim 8, wherein the copy operation is associated with two or more data items.

15. A computer-program product for providing nullification of unintentionally copied data, the computer-program product comprising a computer-readable storage medium having program instructions embodied therewith, the program instructions executable by a processor to cause the processor to perform a method comprising:
detecting a copy operation associated with a data item;
determining whether the data item associated with the copy operation comprises valid data, wherein a determination is made that the data item does not comprise valid data based at least in part on determining that the data item is empty;
recalling a previously stored data item, in response to determining that the data item associated with the copy operation does not comprise valid data;
storing the data item associated with the copy operation, in response to determining that the data item associated with the copy operation comprises valid data; and
initiating a paste operation to selectively insert the data item associated with the copy operation or the previously stored data item based on the validity of data into an application.

16. The computer-program product of claim 15, the method further comprising determining an application associated with the copy operation.

17. The computer-program product of claim 16, the method further comprising determining whether the application associated with the copy operation is the same as the application associated with the paste operation.

18. (canceled)

19. The computer-program product of claim 15, wherein determining whether the data item associated with the copy operation comprises valid data further comprises analyzing a plurality of previously stored items to identify one or more data patterns.

20. The computer-program product of claim 19, the method further comprising determining whether the data item associated with the copy operation matches the one or more data patterns.
